(19) United States
(12) Patent Application Publication
(10) Pub. No.: US 2010/0245189 A1
(43) Pub. Date: Sep. 30, 2010

(54) Vehicle-Mounted Antenna Device

(76) Inventor: Jinsong Wang, Tokyo (JP)

Correspondence Address: WELLS ST. JOHN P.S., 601 W. FIRST AVENUE, SUITE 1300, SPOKANE, WA, 99201, US

(21) Appl. No.: 12/746,159

(22) PCT Filed: Nov. 27, 2008
(86) PCT No.: PCT/JP2008/003494

§ 371 Date: Jun. 8, 2010

(30) Foreign Application Priority Data
Dec. 6, 2007 (JP) 2007-315639`

(51) Int. Cl. H01Q 1/32

(52) U.S. Cl. 343/713

(57) ABSTRACT

A vehicle-mounted antenna device is one in which rain water etc. do not accumulate around an antenna mast base structure and allowing a reduction of the antenna height. The vehicle-mounted antenna device having an antenna mast is constructed mainly from a base plate (10) on which a circuit board (11) is placed, a housing (20), and the antenna mast base structure (30) having a foldable structure. The housing (20) has a water discharge flow path (40) formed in a linear shape as viewed as viewed from the upper portion of the vehicle-mounted antenna device. The water discharge flow path (40) extends continuously underneath the antenna mast base structure while being inclined relative to the base plate. The water discharge flow path is constituted by, for example, the water discharge groove (41), which is formed at the bottom portion of the antenna mast receiving groove (22), and the water discharge flow path-cum-antenna mast receiving groove (42).

### TECHNICAL FIELD

The present invention relates to a vehicle-mounted antenna device, and more particularly to a vehicle-mounted antenna device having a structure in which liquid such as rain water or muddy water is difficult to accumulate in a housing.

### BACKGROUND ART

Examples of a vehicular antenna device include a vehicle-mounted antenna device that is provided on the roof of a vehicle and has an antenna mast extending from an antenna base, and a film antenna device designed to be attached to a window glass. Examples of the vehicle-mounted antenna device include one having a fixed type antenna mast and one having a foldable antenna mast. Further, examples of the foldable type vehicle-mounted antenna device include one in which the antenna mast can be folded only to one side and one in which the antenna mast can be folded to both sides.

In the case of the foldable antenna, a folding structure on which the antenna mast is disposed is provided in the upper portion of a housing, and a circuit board on which an amplifier circuit and the like are placed is provided inside the housing. Patent Document 1 or Patent Document 2 discloses an example of an antenna device in which a wall is used to partition the inside of the housing into two front and rear parts, in one of which the circuit board is provided, in the other of which the folding structure is provided. In this example, the space in which the circuit board is provided is hermetically sealed by the partition wall to prevent rain water or the like from entering the space.

Further, there is known an example of the foldable type vehicle-mounted antenna in which there is formed a groove receiving the folded antenna mast on the housing.

### Patent Document 1:

Japanese Patent Application Kokai Publication No. 2006-108848

### Patent Document 2:

Japanese Patent Application Kokai Publication No. 2006-121369

### DISCLOSURE OF THE INVENTION

### Problems to be Solved by the Invention

In the case of an existing vehicle-mounted antenna device, rain water or the like may accumulate inside the housing or the antenna device main body at a portion around an antenna mast base structure in which the antenna mast is provided. Particularly, in the case of a foldable type vehicle-mounted antenna device having as an antenna mast base, water may accumulate in a space for the rotational movement of the folding.

In the case of the conventional foldable type vehicle-mounted antenna device in which the antenna mast receiving groove is formed, rain water or the like may accumulate in such groove. In the antenna device having a horizontally-extending antenna mast receiving groove, discharge of rain water cannot be achieved by its own weight but achieved depending on the wind during driving.

In the antenna device disclosed in Patent Document 1 or Patent Document 2, the space in which the circuit board is provided is hermetically sealed to prevent rain water from entering the space. However, the space in which the folding structure is provided is not hermetically sealed, rain water may accumulate in this space. The accumulation of rain water or muddy water inside the folding structure may impede smooth movement of the folding structure or may cause corrosion of a terminal portion in the folding structure.

Further, in the case where the folding structure is provided in the upper portion of the housing, the height dimension of the antenna device is increased. This not only impairs the outer appearance of the antenna device but also adversely affects aerodynamic characteristics as well as restricts to enter to a location where height limitation is imposed. In the antenna device disclosed in Patent Document 1 or Patent Document 2, the circuit board and the folding structure are arranged not one above the other but in back and forth direction. Thus, although it is possible to suppress the height dimension of the antenna device to some extent, the space for the circuit board is restricted due to back and forth arrangement of the circuit board and the folding structure, making it difficult to increase the size of the circuit board. This results in difficulty of achieving a multi-frequency structure involving increase in the circuit scale.

Further, in the case of the foldable type vehicle-mounted antenna device with the horizontally-extending antenna mast receiving groove, when the height dimension of the housing of the antenna device is excessively reduced, the antenna mast, if it is horizontally folded, may beat the roof during driving due to vibration of a vehicle.

The present invention has been made in view of the above situation, and an object thereof is to provide a vehicle-mounted antenna device capable of preventing rain water or the like from accumulating around the antenna mast base structure and achieving a reduction in the antenna height.

### Means for Solving the Problems

To attain the above object, according to the present invention, there is provided a vehicle-mounted antenna device having an antenna mast, the vehicle-mounted antenna device comprising: a base plate on which a circuit board is placed; a housing covering the base plate; an antenna mast base structure, on which the antenna mast is provided, fitted to the housing; and a water discharge flow path linearly formed in the housing as viewed from the upper portion of the vehicle-mounted antenna device, which extends continuously underneath the antenna mast base structure while being inclined relative to the base plate.

The antenna mast base structure may have a folding structure allowing the antenna mast to be foldable. The housing may have an antenna mast receiving groove for receiving the antenna mast which is formed so as to be inclined relative to the base plate. The water discharge flow path may include a water discharge groove formed in the antenna mast receiving groove.

The antenna mast base structure may have a folding structure allowing the antenna mast to be foldable in two directions. The housing may have first and second antenna mast receiving grooves for receiving the antenna mast, the first antenna mast receiving groove extending in one folding direction of the antenna mast while being inclined relative to the base plate, and the second antenna mast receiving groove extending in the other folding direction of the antenna mast while being inclined relative to the base plate. The water discharge flow path may be constituted by the first antenna mast receiving groove and a water discharge groove formed in the second antenna mast receiving groove.

The inclination angles of the first antenna mast receiving groove and water discharge groove with respect to the base plate may be equal to each other.

The antenna mast base structure may be mounted on the circuit board placed on the base plate.

The circuit board placed on the base plate may have a slit portion of a size to which the water discharge flow path is fitted.

The water discharge flow path may further have a tributary flow path.

### ADVANTAGES OF THE INVENTION

The vehicle-mounted antenna device according to the present invention has advantages of preventing rain water or the like from accumulating around the antenna mast base structure provided on the housing and allowing a reduction of the antenna height.

### BRIEF DESCRIPTION OF THE DRAWINGS

FIG. 1 is a view for explaining a vehicle-mounted antenna device according to the present invention.

FIG. 2 is a view for explaining an example in which the antenna height of the vehicle-mounted antenna device according to the present invention is reduced.

FIG. 3 is a top view for explaining another example of the vehicle-mounted antenna device according to the present invention.

FIG. 4 is a top view for explaining an example in which a water discharge groove of the vehicle-mounted antenna device according to the present invention is made shorter.

### EXPLANATION OF REFERENCE SYMBOLS

10: Base plate
11, 12: Circuit board
13: Slit portion
15: Pinching terminal
20: housing
22, 23: antenna mast receiving groove
25: Conductive terminal
26: Support portion
27: Hole
30: Antenna mast base structure
31: Antenna mast
32: Joint portion
33: Conductive terminal
34: Click cylinder
35: Spring
36: Nut
37: Small spring
40: Water discharge flow path
41, 43: Water discharge groove
42: Water discharge flow path-cum-antenna mast receiving groove

### BEST MODE FOR CARRYING OUT THE INVENTION

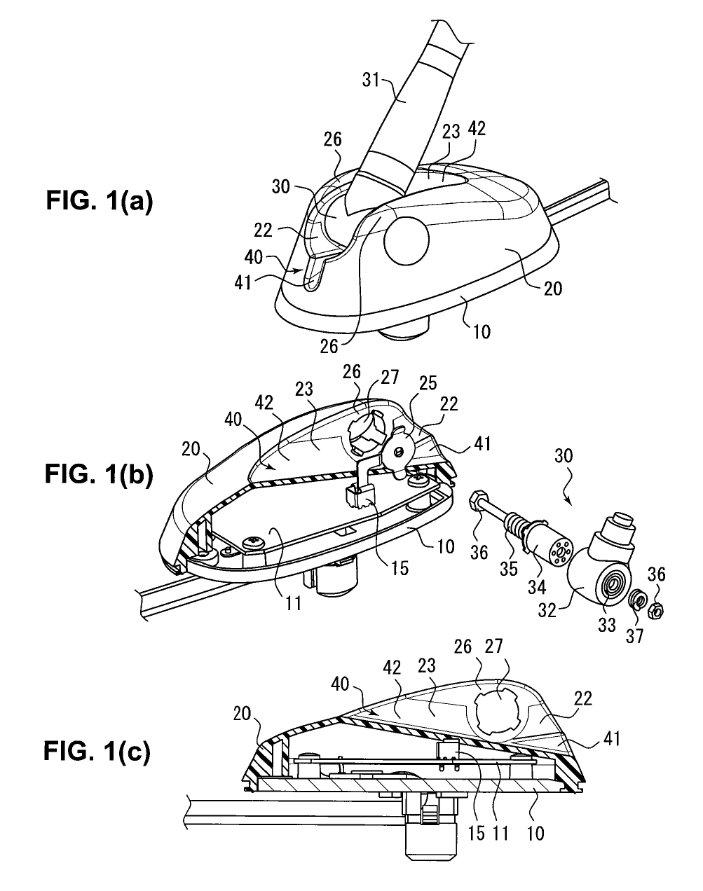

A preferred embodiment for practicing the present invention will be described below with reference to the accompanying drawings. FIG. 1 is a view for explaining a vehicle-mounted antenna device according to the present invention. FIG. 1(a) is a perspective view of the vehicle-mounted antenna device, FIG. 1(b) is a partly cross-sectional exploded perspective view thereof as viewed from the opposite side to the side of viewing of FIG. 1(a), and FIG. 1(c) is a partly side cross-sectional view thereof. Note that illustration of an antenna mast is omitted in FIG. 1(b) and illustration of an antenna mast base structure is omitted in FIG. 1(c). In this example, a case where the present invention is applied to a vehicle-mounted antenna device having a both side folding structure is illustrated. As illustrated in FIGS. 1(a) to 1(c), the vehicle-mounted antenna device of the present invention mainly includes a base plate 10, a housing 20, and an antenna mast base structure 30. A water discharge flow path 40 extends inside the housing 20.

The base plate 10 has a boss portion to be inserted into a hole formed in the roof of a vehicle, and a cable is fed through the boss portion. A circuit board 11 is placed on the base plate 10. The circuit board 11 has thereon an amplifier circuit, a filter circuit, and the like. In the vehicle-mounted antenna device of the present invention, the size of the circuit board 11 can be made substantially equal to the size of the base plate 10, thereby ensuring a sufficient circuit arrangement area. Therefore, even a large-scale circuit handling a plurality of frequencies can be mounted on the circuit board.

The housing 20 is provided so as to cover the base plate 10 and defines the outer appearance of the vehicle-mounted antenna device. The housing 20 has an internal space defined by the base plate 10. The circuit board 11 is provided in this space and thereby waterproofed. The bonded surface between the housing 20 and the base plate 10 may be sealed by a predetermined packing material for waterproof. Any conventional or future developed waterproof structure may be applied to the waterproof structure used in the present invention.

The antenna mast base structure 30 is a structure to which an antenna mast 31 is fixed and is fitted to the housing 20. The antenna mast base structure 30 of the illustrative example has a folding structure in which the antenna mast can be folded along the longitudinal direction of the housing as viewed from the upper side of the vehicle-mounted antenna device.

For example, the antenna mast base structure 30 mainly includes a joint portion 32, a click cylinder 34, a spring 35, and a bolt and nut 36.

The antenna mast 31 is screwed to the joint portion 32 so as to be fixed. The joint portion 32 has a bottomed cylinder portion extending in the direction perpendicular to the folding direction. The bottomed cylinder portion has at its bottom a surface slidably fitted to a conductive terminal 25 provided in a support portion 26 to be described later. This surface has a conductive terminal 33 electrically contacting the conductive terminal 25.

The click cylinder 34, which has a bottomed cylindrical shape, is biased into the bottomed cylinder portion of the joint portion 32 by an elastic member, more particularly, the spring 35 and provides click feeling at the folding time of the antenna mast. In order to provide click feeling, a plurality of concaves or convexes are formed in the bottom surface of the click cylinder 34 that is slidably fitted to the joint portion 32 and correspondingly-fitted convexes or concaves are formed in the bottom of the joint portion 32.

The click cylinder 34 and the joint portion 32 are held between a pair of support portions 26 provided in the housing by the bolt and nut 36, whereby the joint portion 32 is supported so as to freely pivot. With this configuration, a folding structure allowing the antenna mast to be folded in two directions can be provided. The folding structure used as the antenna mast base structure 30 is not limited to that illustrated in the drawings, but any conventional or future developed folding structure may be adopted.

The pair of support portions 26 has holes 27 for receiving insertion of the click cylinder 34 and the bolt and nut 36. Further, one of the support portions 26 has the conductive terminal 25 electrically contacting the conductive terminal 33 provided on the joint portion 32. In the illustrative example, a conductive elastic member, more particularly, a small spring 37 is provided between the conductive terminal 25 and conductive terminal 33 to achieve the electrical contact therebetween. That is, the conductive terminal 25 is provided between the small spring 37 and the nut 36 and is electrically connected to the conductive terminal 33 through the small spring 37.

The conductive terminal 25 ensures electrical connection between the antenna mast and the circuit board. For example, the conductive terminal 25 is insert-molded in the housing. Insert-molding the conductive terminal 25 allows reliable prevention of entering of rain water or the like from the terminal portion into the housing. The antenna mast side of the conductive terminal 25 is formed into a disk shape so as to be slidably fitted and electrically connected to the conductive terminal 33 provided in the joint portion 32 of the antenna mast base structure 30. The circuit board side of the conductive terminal 25 is formed into a plate-like shape so as to directly be inserted into a pinching terminal 15 placed on the circuit board 11. With such a configuration, in the vehicle-mounted antenna device of the present invention, the waterproof property in the housing and workability during assembly can be improved. The structures of the conductive terminals are not limited to those illustrated in the drawing, but the conductive terminals may have any structure as long as it can ensure electrical connection between the antenna mast and the circuit board.

In the vehicle-mounted antenna device of the present invention illustrated in the drawing, antenna mast receiving grooves 22 and 23 for housing the folded antenna mast 31 are formed in the housing 20. The antenna mast receiving grooves 22 and 23 linearly extend as viewed from above while being inclined relative to the base plate 10. More specifically, the antenna mast receiving grooves 22 and 23 are each formed into a depression (groove) deep enough to receive the antenna mast in the folding direction of the antenna mast. In the illustrative example, two antenna mast receiving grooves 22 and 23 constitute a V-shape with their inclination angles so as to be symmetric with respect to the antenna mast base structure 30. A specific example of the inclination angles is about 10 degrees/170 degrees relative to the base plate 10.

In the case where the antenna mast receiving groove is formed in parallel to the base plate to allow the antenna mast to be folded horizontally, the antenna mast, if it is in a horizontally folded state, may beat the roof due to vibration of a vehicle. Therefore, it is preferable that the antenna mast receiving grooves 22 and 23 each have a predetermined inclination angle. Particularly, in the case of a low-height type vehicle-mounted antenna device, the distance between the roof and the antenna mast leading end is reduced, increasing the possibility that the antenna mast beats the roof. Thus, it is preferable that the position of only the antenna mast base structure 30 is lowered while the distance between the antenna mast leading end and the roof is ensured to some extent.

In the case where the antenna mast receiving grooves 22 and 23 constitute a V-shape, liquid such as rain water is likely to accumulate at the apex of the V-shape, i.e., underneath around the antenna mast base structure 30. However, in the vehicle-mounted antenna device of the present invention, the water discharge flow path extending linearly as viewed from above is formed inside the housing to prevent the accumulation of the liquid. In the vehicle-mounted antenna device of the present invention, a water discharge groove 41 is formed inside the antenna mast receiving groove 22. More specifically, the water discharge groove 41 is formed at the bottom portion of the antenna mast receiving groove 22 so as to extend linearly as viewed from the upper side of the vehicle-mounted antenna device while being inclined relative to the base plate 10. In the present specification, the water discharge groove may have any shape as long as it can guide the water. That is, even a concave-shaped groove or a tunnel-shaped flow path is included in the concept of the water discharge groove. This water discharge groove 41 is connected to the antenna mast receiving groove 23 underneath the antenna mast base structure 30. As a result, the water discharge flow path 40 extending continuously from the antenna mast receiving groove 23 to the water discharge groove 41 through underneath the antenna mast base structure is constructed. In the illustrative example, the antenna mast receiving groove 23 serves also as a part of the water discharge flow path 40. That is, the water discharge flow path-cum-antenna mast receiving groove 42 and the water discharge groove 41 constitute the water discharge flow path 40.

In the vehicle-mounted antenna device of the present invention, the water discharge flow path may have variable widths as long as it is formed so as to extend linearly as viewed from the upper side of the vehicle-mounted antenna device. In the illustrative example, although the water discharge flow path-cum-antenna mast receiving groove 42 and the water discharge groove 41 have different widths, the grooves 42 and 41 extend linearly as viewed from the upper side of the vehicle-mounted antenna device. That is, when the grooves are continuously formed such that there exists no location in which liquid such as rain water accumulates, the effect of the present invention can be obtained irrespective of the variation of the width of the groove.

Further, in the vehicle-mounted antenna device of the present invention, the extending directions of the water discharge flow path and the antenna mast receiving groove are not limited to the longitudinal direction as viewed from the upper side of the vehicle-mounted antenna device as illustrated in the drawing, but the grooves may be formed so as to extend in the diagonal direction or short traverse direction. However, as to the water discharge flow path, the extending direction is preferably parallel to the traveling direction of a vehicle in which the vehicle-mounted antenna device is provided in order to obtain water discharge effect produced by the wind during driving.

Further, only one water discharge flow path 40 is formed in the housing 20 so as to extend in the longitudinal direction as viewed from the upper side of the vehicle-mounted antenna device in the illustrative example. However, the present invention is not limited to this but a plurality of flow paths may be formed. For example two water discharge flow paths extending in parallel to each other may be formed in the longitudinal direction. Further, a tributary flow path extending in a direction other than the longitudinal direction may be formed. More specifically, a tributary flow path branched from the water discharge flow path extending linearly as viewed from the upper side of the vehicle-mounted antenna device may be formed so as to extend in the traverse direction while being inclined outwardly downward relative to the base plate.

When the vehicle-mounted antenna device of the present invention is splashed with liquid such as rain water, the liquid flows, by its own weight, from the antenna mast receiving groove 23 side to the antenna mast base structure 30 side and further to the water discharge groove 41 through underneath the antenna mast base structure 30. Finally, the liquid is discharged outside the vehicle-mounted antenna device from the end portion of the water discharge groove 41. During driving, wind force is applied to blow off the liquid and, similarly, the liquid is discharged outside through the water discharge flow path 40.

In the illustrative example, the water discharge flow path 40 is inclined gradually downward from the longitudinal direction of the housing left to right as viewed in FIG. 1(c). However, the present invention is not limited to this, but the water discharge flow path 40 may be inclined gradually upward from the longitudinal direction left to right as viewed in FIG. 1(c). That is, the water discharge flow path only needs to be inclined such that liquid such as rain water is discharged outside by its own weight.

Further, in the water discharge flow path 40 of the illustrative example, the antenna mast receiving groove 23 and the water discharge groove 41 have the same inclination angle and therefore the bottom portions of the antenna mast receiving groove 23 and the water discharge groove 41 continue in a linear fashion. However, the present invention is not limited to this, but the antenna mast receiving groove 23 and water discharge groove 41 may have different inclination angles, as long as the water discharge flow path 40 is formed without a break in continuity and is capable of preventing accumulation of the liquid. For example, a configuration may be adopted in which the water discharge groove 41 is formed at the bottom of the antenna mast receiving groove 22 so as to be inclined outwardly downward and another water discharge groove is formed at the bottom of the antenna mast receiving groove 23 so as to be inclined outwardly downward such that the two grooves extend symmetrically with respect to the antenna mast base structure 30. That is, the water discharge flow path 40 may be designed such that the liquid is discharged, by its own weight, outwardly with respect to the antenna mast base structure in both the front and rear directions. Further, a step small enough to keep the liquid from accumulating may be formed as needed in the middle of the water discharge flow path. For example, a step may be formed at a part of the water discharge flow path positioned underneath the antenna mast base structure so as to lower the position of the antenna mast base structure. This allows a reduction in the height of the entire vehicle-mounted antenna device.

According to the vehicle-mounted antenna device of the present invention, it is only necessary to incline the water discharge flow path relative to the base plate in order to discharge the water, thereby increasing flexibility in terms of the arrangement position of the antenna mast base structure. In the illustrative example, the antenna mast base structure is displaced from the center of the vehicle-mounted antenna device. However, the present invention is not limited to this, but the antenna mast base structure may be positioned at the center of the vehicle-mounted antenna device so as to make the vehicle-mounted antenna device have a symmetrical shape with respect to the center thereof. Further, in the illustrative example, the antenna mast base structure 30 is provided above the circuit board 11. Since the water discharge is smoothly performed in the vehicle-mounted antenna device of the present invention, it is possible to freely arrange the antenna mast base structure 30 while avoiding the circuit board 11 and circuit parts, fixing screws, or the like placed on the circuit board 11. Therefore, the antenna mast base structure can be arranged at a low-height position directly above the circuit board. This makes it possible to reduce the height of the antenna device while ensuring the area of the circuit board.

In the illustrative example, a folding structure is used as the antenna mast base structure 30, wherein the click cylinder or the like is inserted through the hole 27 formed in the housing 20, and the joint portion 32 is supported by a pair of the support portions 26 provided in the housing 20 side. However, the present invention is not limited to this. For example, a support structure in which a pair of support arms is mounted on a base portion may be used, wherein the joint portion is held between the support arms, and the base portion of the support structure is fixed to the housing. In this case, when a water discharge groove is formed at the base portion of the support arms positioned below the joint portion so as to be integrated with the water discharge flow path formed inside the housing, it is possible to realize the water discharge flow path continuously extending inclined from the front side to rear side in the longitudinal direction of the housing. In the case of the antenna mast base structure having such a support arm structure, the antenna mast base structure is previously assembled and the assembled antenna mast base structure is fit in a predetermined installation position provided in the housing side, followed by integration of antenna mast base structure and housing by ultra sonic welding or the like.

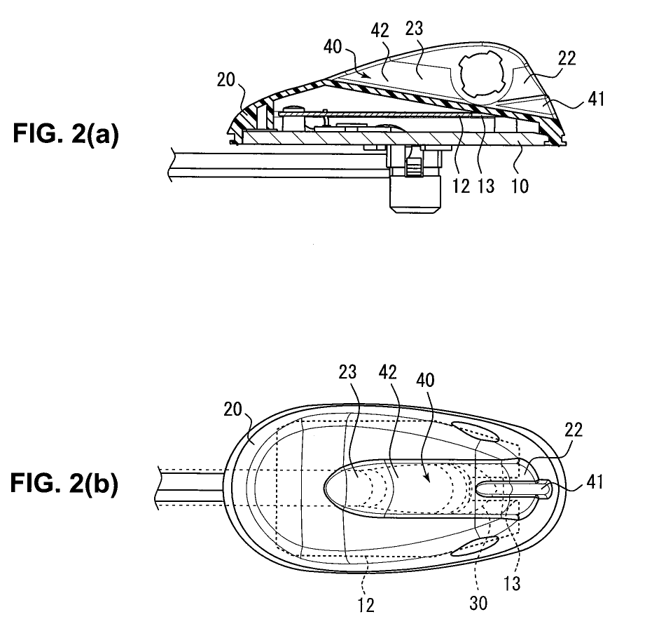

Next, an example in which the antenna height of the vehicle-mounted antenna device is further reduced will be described with reference to FIG. 2. FIG. 2 is a view for explaining an example in which the antenna height of the vehicle-mounted antenna device according to the present invention is reduced, FIG. 2(a) is a partly side cross-sectional view of the vehicle-mounted antenna device, and FIG. 2(b) is a top view thereof. In FIG. 2(b), the circuit board is represented by broken lines. In FIG. 2, the same reference numerals as those in FIG. 1 denote substantially the same parts as those in FIG. 1. The antenna mast base structure 30 and antenna mast are omitted in FIG. 2(a) and represented by broken lines in FIG. 2(b). In the vehicle-mounted antenna device illustrated in FIG. 2, a slit portion 13 of a size to which a water discharge groove 41 constituting a part of the water discharge flow path is fitted is formed in the circuit board 12. Forming the slit portion 13 allows the position of the water discharge groove 41, which is located at the lowest position in the internal space of the housing 20, to be further lowered without being influenced by the circuit board. Thus, it is possible to lower the positions of the antenna mast base structure and water discharge flow path while ensuring the area of the circuit board to some extent. By forming the slit portion of a size to which a part of the water discharge flow path is fitted in the circuit board as described above, a lower-height type vehicle-mounted antenna device can be realized. Further, the flexibility in terms of the arrangement positions of the circuit board and the water discharge flow path can be increased.

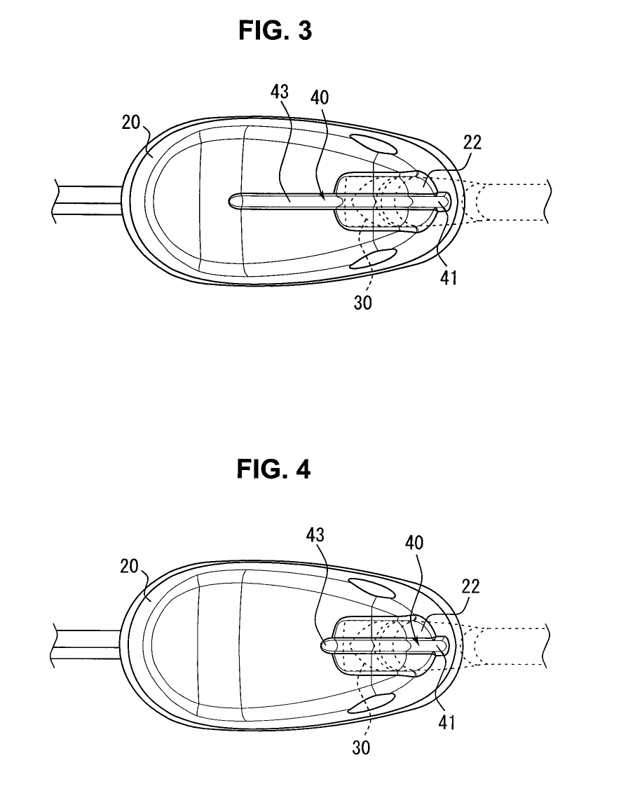

Next, another example of the vehicle-mounted antenna device according to the present invention will be described with reference to FIG. 3. FIG. 3 is a top view for explaining another example of the vehicle-mounted antenna device according to the present invention. In FIG. 3, the same reference numerals as those in FIG. 1 denote substantially the same parts as those in FIG. 1. The antenna mast base structure 30 and the antenna mast are represented by broken lines. Although the antenna mast is folded in two directions in FIG. 1, a configuration in which the antenna mast is folded only in one direction may be adopted in the vehicle-mounted antenna device according to the present invention. In the housing 20 illustrated in FIG. 3, the antenna mast receiving groove 22 is formed only on one side and thus the antenna mast base structure 30 can be folded only to one side. The antenna mast base structure 30 may have the same structure as that illustrated in FIG. 1 or may have any conventional or future developed folding structure.

The water discharge groove 41 constituting a part of the water discharge flow path 40 is formed at the bottom of the antenna mast receiving groove 22. Like the water discharge groove illustrated in FIG. 1, the water discharge groove 41 is inclined relative the base plate so as to discharge liquid such as rain water to the outside of the antenna device. Further, a water discharge groove 43 is formed at a position on the opposite side to the antenna mast receiving groove 22 with respect to the antenna mast base structure 30. Like the water discharge groove 41, the water discharge groove 43 extends linearly as viewed from the upper portion of the vehicle-mounted antenna device while being inclined relative to the base plate. The water discharge groove 43 extends underneath the antenna mast base structure 30 and is connected continuously to the water discharge groove 41. That is, the antenna mast receiving groove 22 is used also as a part of the water discharge flow path in the vehicle-mounted antenna device illustrated in FIG. 1, while in the example of FIG. 3, the water discharge groove 43 is not used as the antenna mast receiving groove.

As described above, in the vehicle-mounted antenna device of the illustrative example having the folding structure in which the antennas mast is folded only to one side, the water discharge flow path 40 extending linearly as viewed from the upper portion of the vehicle-mounted antenna device and continuously from the water discharge groove 43 to the water discharge groove 41 through underneath the antenna mast base structure 30 is constructed. That is, the water discharge groove 43 and the water discharge groove 41 constitute the water discharge flow path 40.

The width of the water discharge groove 43 is the same as, as illustrated in FIG. 3, or different from that of the water discharge groove 41. For example, the water discharge groove may be tapered from the water discharge groove 41 to the water discharge groove 43.

In the illustrative example, the water discharge groove 43 has a certain degree of length. However, the present invention is not limited to this, but the water discharge groove 43 may be made shorter. FIG. 4 is a top view for explaining an example in which a water discharge groove 43 of the vehicle-mounted antenna device according to the present invention is made shorter. In FIG. 4, the same reference numerals as those in FIG. 3 denote substantially the same parts as those in FIG. 3. As illustrated in FIG. 4, the water discharge groove 43 is made shorter. However, as is the case with the above-described examples, the water discharge flow path 40 extends continuously from the water discharge groove 43 to the water discharge groove 41 through underneath the antenna mast base structure 30 while being inclined to the base plate.

The vehicle-mounted antenna device according to the present invention only needs to be designed such that the water discharge flow path 40 is formed so as to be extended linearly as viewed from the upper portion of the vehicle-mounted antenna device and that liquid is discharged outside not only by its own weight but also by wind during driving. Thus, the water discharge groove 43 may be of a length corresponding to a certain amount of space as illustrated in FIG. 4.

In the vehicle-mounted antenna devices of the above illustrative examples, the antenna mast base structure has the folding structure. However, the present invention is not limited to this but may be applied to the vehicle-mounted antenna device having a fixed type antenna mast. That is, even in the case where a vehicle-mounted antenna device has a structure in which the antenna mast base structure is not designed as the folding type and in which rain water or the like accumulates in the screwing portion of the antenna mast, it is possible to discharge liquid such as rain water by adopting the water discharge flow path of the present invention.

The vehicle-mounted antenna device according to the present invention is not limited to the above illustrative examples, but various modifications may be made without departing from the scope of the present invention.

1. A vehicle-mounted antenna device having an antenna mast, the vehicle-mounted antenna device comprising:
a base plate on which a circuit board is placed;
a housing covering the base plate;
an antenna mast base structure, on which the antenna mast is provided, fitted to the housing; and
a water discharge flow path linearly formed in the housing as viewed from the upper portion of the vehicle-mounted antenna device, which extends continuously underneath the antenna mast base structure while being inclined relative to the base plate.

2. The vehicle-mounted antenna device according to claim 1, in which the antenna mast base structure has a folding structure allowing the antenna mast to be foldable,
the housing has an antenna mast receiving groove for receiving the antenna mast, the antenna mast being formed so as to be inclined relative to the base plate, and
the water discharge flow path includes a water discharge groove formed in the antenna mast receiving groove.

3. The vehicle-mounted antenna device according to claim 1, in which
the antenna mast base structure has a folding structure allowing the antenna mast to be foldable in two directions,
the housing has first and second antenna mast receiving grooves for receiving the antenna mast, the first antenna mast receiving groove extending in one folding direction of the antenna mast while being inclined relative to the base plate, and the second antenna mast receiving groove extending in the other folding direction of the antenna mast while being inclined relative to the base plate, and
the water discharge flow path is constituted by the first antenna mast receiving groove and a water discharge groove formed in the second antenna mast receiving groove.

4. The vehicle-mounted antenna device according to claim 3, in which the inclination angles of the first antenna mast receiving groove and water discharge groove with respect to the base plate are equal to each other.

5. The vehicle-mounted antenna device according to claim 1, in which the antenna mast base structure is mounted on the circuit board placed on the base plate.

6. The vehicle-mounted antenna device according to claim 1, in which the circuit board placed on the base plate has a slit portion of a size to which the water discharge flow path is fitted.

7. The vehicle-mounted antenna device according to claim 1, in which the water discharge flow path further has a tributary flow path.
